(19) United States
(12) Patent Application Publication
(10) Pub. No.: US 2004/0007558 A1
(43) Pub. Date: Jan. 15, 2004

(54) Manufacturing method for high-density type copper plate memorial

(76) Inventor: Woo Youl Sim, Seoul (KR)

Correspondence Address: JACOBSON HOLMAN PLLC, 400 SEVENTH STREET N.W., SUITE 600, WASHINGTON, DC, 20004, US

(21) Appl. No.: 10/424,147

(22) Filed: Apr. 28, 2003

Related U.S. Application Data
(63) Continuation of application No. 09/636,829, filed on Aug. 14, 2000, now abandoned.

(51) Int. Cl. B44C 1/22

(52) U.S. Cl. 216/32

(57) ABSTRACT

This invention relates to a manufacturing method for a high-density copper plate memorial which comprises the following steps of: digitalizing the desired image for its storage in a computer file (S100); adjusting the image level by converting the stored image into halftone image (S102); printing the halftone image into a transparent film (S104); coating the surface of the foreign materials-free copper plate with a glue containing a hardening agent and photosensitizer, followed by its drying (S106); compressing the printed image film to the copper plate for its photosensitization (S108); heating the glue for appropriate etching (S110); etching the surface of copper plate using an impregnating agent to form about 1000˜1600 dots per cm² (S112); coating the etched copper plate with a painting material to obtain the same image as the image printed on a film (S114); sanding the copper plate to obtain the desired surface roughness (S116); and, coating the copper plate with a protective film so as to protective the surface of the copper plate where the above mentioned image is formed (S118).

Through the following several steps, therefore, this invention can provide the copper plate memorial with the high-density and high-clarity image reproduction: (1) a step of digitalizing the desired image for its storage in a computer file, (2) a step of converting the stored image into halftone image using a graphic edition program, (3) a step of printing the halftone image into a transparent film as a raw data for micro-dots, and (4) the copper plate is etched to form about 1,000˜1,600 dots per cm².

### FIELD OF THE INVENTION

This invention relates to a manufacturing method for a high-density copper plate memorial and more particularly, to the high-density copper plate memorial engraving a desired micro-image at the surface of the copper plate by increasing the number of dot of dots per cm² significantly using a computer graphic editing program, thus enhancing the resolution of the copper plate memorial.

### DESCRIPTION OF THE RELATED ART

Throughout his/her whole life, one will encounter a variety of personal cerebrations, i.e., the feasts of a hundred-day-old baby and of a one-year baby after birth, entrance and graduation ceremonies from kindergarten, elementary school, middle school, high school and university, a cerebration of one's coming of age, an engagement, a marriage, banquets on one's 60th/70th birthday, and a variety of 10-year marriage cerebrations (e.g., a silver ceremony and gold ceremony). To memorize or cerebrate these cerebrations for a long period of time, people used to take a picture.

In the case of national/local commemorative events or individual events such as commencement of business including various ceremonies, people used to take a picture for preservation of their historic scenes.

It is typical and general that the scenes of various ceremonies are preserved by photos.

Further, participants in various ceremonies used to record his/her names in a guest book for the purpose of congratulating their host. When those people, who have had long careers in government affairs, private business or military service, transfer or leave his/her jobs, his/her colleagues used to present them with a commemorative plaque for congratulating his/her previous services or in the hope of their bright future.

Those who record his/her names in the guest book happen to make additional writing such as well wishing remarks and encouragement for the host and in some cases, the host may be successful in his/her careers due to such remarks.

However, a variety of commemorative souvenirs such as photos, paper-based guest book and plaques become discolored and torn down after the lapse of time. Especially, the commemorative plaques containing the stereo-type phrases are poorly manufactured and they are liable to be easily broken by a light impact, thus losing their storage value. In addition, the photos and guest books become discolored, when exposed to sunlight and electric boobs. Their common life-span is said to be about 50 years.

The fact that any memorial for the commemoration of special event loses its storage value is quite disappointing to the host.

Recently, in an effort to preserve the memorial on a semi-external basis, a method for engraving some photos or messages on a metal-based plate (mainly, copper plate) has been disclosed.

However, such conventional copper plate has recognized some disadvantages in that with less dots per cm², the density of the plate is significantly reduced and its quality becomes poor, when the photos are reproduced.

To comply with the aforementioned shortcomings, an object of this invention is to provide a manufacturing process for a high-density copper plate memorial in such a manner to realize more micro-imagination of desired materials by significantly increasing the number of dot per cm² via a computer graphic editing program.

### SUMMARY OF THE INVENTION

This invention is derived from a concept that through the decomposition of images consisting of photos or letter messages, the decomposed micro-particles, which can be discernible by naked eyes, are engraved on the copper plate. Thus, a memorial to be prepared by the method of this invention can be preserved for more than 1,000 years without any deterioration or discoloration on copper plate.

### BRIEF DESCRIPTION OF THE DRAWINGS

FIG. 1 is a flow diagram showing the manufacturing process for a high-density copper plate memorial according to this invention;

FIG. 2 is a photo showing one example of a transparent film where the image used for this invention is printed;

FIG. 3 is a photo showing the copper plate immediately after the etching process of this invention;

FIG. 4 is a photo showing that a painting material is applied to the surface of copper plate according to this invention;

FIG. 5 is a photo showing the comparison between one site performing the sanding process and the other without the sanding process; and,

FIG. 6 is a photo showing one example of the finally completed copper plate through the coating process of a protective film according this invention.

### DETAILED DESCRIPTION OF THE INVENTION

To achieve the above objective, this invention is characterized by the method of preparing a high-density copper plate memorial, wherein it comprises the following steps of:

digitalizing the desired image for its storage in a computer file;

adjusting the image level by converting the stored image into halftone image; Printing the halftone image into a transparent film;

coating the surface of the foreign materials-free copper plate with a glue containing a hardening agent and photosensitizer, followed by its drying;

compressing the printed image film to the copper plate for its photosensitization;

heating the glue for appropriate etching; and, coating the copper plate with a protective film so as to protective the surface of the copper plate where the above mentioned image is formed.

Through the following several steps, therefore, this invention can provide the copper plate memorial with the high-density image, which cannot be realized in the convention copper plate material having 90 dots per cm²: (1) a step of digitalizing the desired image for its storage in a computer file, (2) a step of converting the stored image into halftone image using a graphic edition program, (3) a step of printing the halftone image into a transparent film as a raw data for micro-dots, and (4) the copper plate is etched.

Now that this invention can realize the image containing micro-particles (about 1,000˜1600 dots per cm²) on the copper plate, the copper plate, a high-density and high-clarity image can be formed on the copper plate.

This invention is explained in more detail by referring to the accompanying drawings.

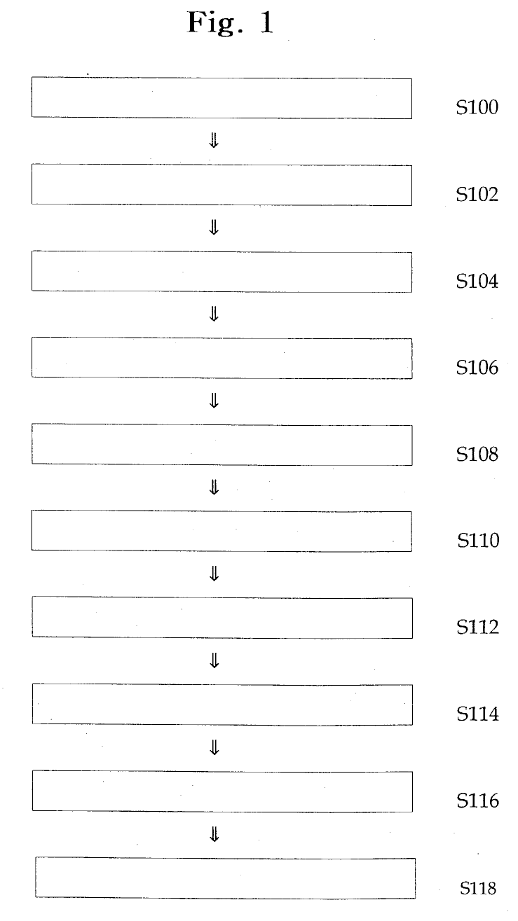

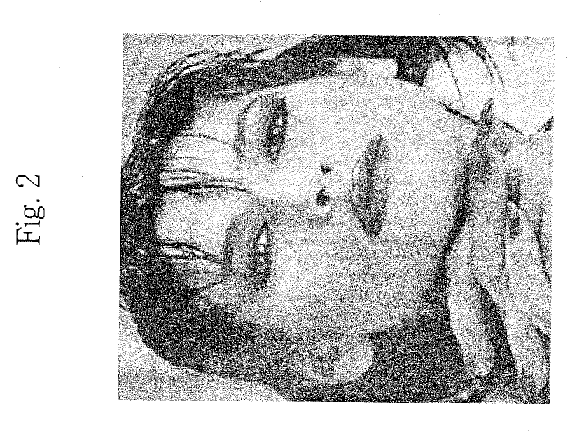

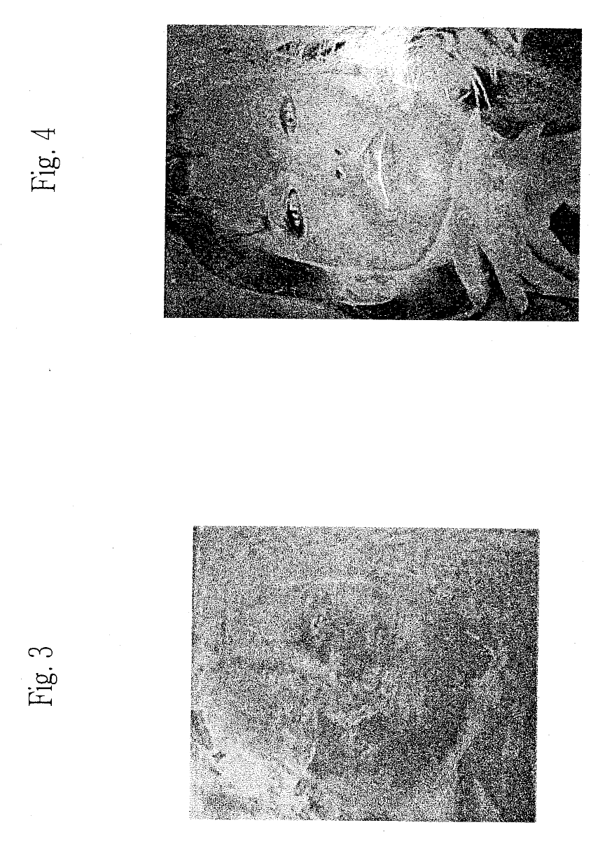

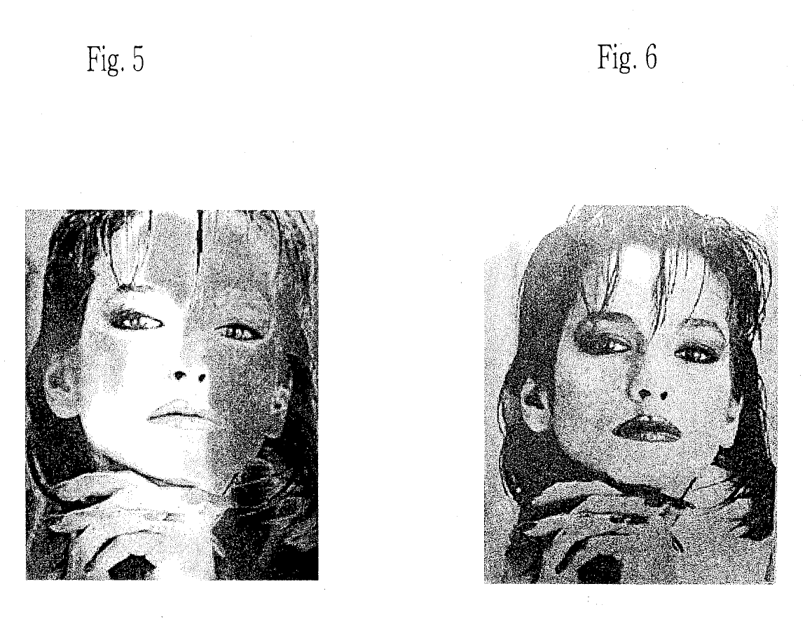

FIG. 1 is a flow diagram showing the manufacturing process for a high-density copper plate memorial according to this invention; FIG. 2 is a photo showing one example of a transparent film where the image used for this invention is printed; FIG. 3 is a photo showing the copper plate immediately after the etching process of this invention; FIG. 4 is a photo showing that a painting material is applied to the surface of copper plate according to this invention; FIG. 5 is a photo showing the comparison between one site performing the sanding process and the other without the sanding process; and, FIG. 6 is a photo showing one example of finally completed copper plate through the coating process of a protective film according this invention.

[Preparation of Image Film]

First, some image memorials (e.g., photos, drawings, guest books, etc.). These images can be stored into a computer file, either using analogue cameras and scanner or using digital cameras for the direct input of images to a computer (S100). It is the most common method to use a scanner, since it can grasp the imaging as a real form.

Alternatively, the image for the manufacture of the copper plate memorial may be obtained by downroading the already digitalized photo-images from the Internet.

The image file stored in a computer is opened using a graphic editing program such as Adobe Photoshop so as to adjust the images level (S102).

The adjustment for the image level means that the image is under halftone for the formation of desired dots on the copper plate from the post-process.

Based upon the number of dots per cm, the clarity of memorial such as a copper-plate photo (hereinafter referred to as “memorial”) can be determined and the high-quality memorials can also be manufactured.

More specifically, the term “halftone” refers to a screen ruling, and the term “a screen ruling” means the halftone cells per cm² or the number of printer dots, which is used for printing a gray shadow image and color plate. Further, the number of screen line, known as the screen line drawing, refers to the number of halftone cells per cm² in the halftone screen, which is measured by line per inches (1 pi) or line per cm².

The quality of various components from the printed image can be determined by the correlation between the image resolution and screen ruling.

In general, to produce the high-quality halftone image, the image resolution having 1.5˜2 times of screen ruling. However, in some cases, the use of low resolution depending on the image and output device may produce better results.

The number of halftone for the manufacture of copper plate is 90 dots per cm² but it can be increased up to 1,000˜1600 dots per cm² when using a film whose dot is formed by halftone based on the graphic program according to this invention.

Therefore, a high-density copper plate memorial with better quality can be prepared.

Then, the halftone image is printed on a transparent film (S104). FIG. 2 is a photo showing one example of a transparent film where the image used for this invention is printed.

In the case of a gray shadow halftone, the number of screen ruling ranging from 1 to 999.999 is inputted into a ruling text box to select the measurement unit. In the case of an angle, the angle ranging from −180 to +180 degrees is inputted into the box.

The copper plate is manufactured using a single color classifying the gray shadows by step, and the following matters should be considered for the manufacture of the copper plate.

The halftone screen consists of dots which can control the amount of ink at the specific location of a printer. A ghost on the change in gray or continuous colors may be prepared by changing the size and density of dot. In the case of a combination color image, the halftone screen using four different printer inks (e.g., cyan, magenta, yellow and black) is provided.

For example, in the case of a halftone screen using a black ink, the halftone screen of combination ink established as other screen angles or accurately fixed dots forms a rose.

Through the typical printing, the halftone screen is placed between the film and image and the film is exposed to produce the halftone.

The program designating the property of halftone screen is preferred before making a film or outputting the paper. To ensure the best results, the accurate density limit of the output device should be established, while modifying the values of processor. If unprepared, the results cannot be expected.

If the menu for user's definition screen is selected from the above program, the selection of initial screen use in printer is cancelled; if the initial-value halftone screen stored in the printer, the initial screen use is selected.

The explanation for the expected color plate is omitted herein, since it is far from the concept of this invention due to several options.

[Preparation of Copper Plate]

A clean copper plate with appropriate size was prepared by removing foreign materials on the copper plate through washing process. Then, the surface of copper plate was coated with an glue containing a clarifier and photosensitizer and dried (S106).

The printed image film was compressed to the copper plate and photosensitized for 2˜4 minutes (S108). The photosensitized state on the copper plate was checked and if required, an additional correction process was performed to obtain a final copper plate. The plate coated with the glue was heated at a low temperature (S110) and impregnated with an impregnating agent, such as iron chloride, for 10˜20 minutes to etch the plate (S112). Then, many concave micro-dots (1000˜1600 dots/cm²) were formed on the copper plate. FIG. 3 shows one example of copper plate immediately after etching.

[Preparation of Copper Plate Memorial]

The copper plate etched with desired image on the printed film was coated with the general painting material with desired color (S114). Hence, the painting material was coated on the other surface of the copper plate except for the concave dots and thus an image was formed. However, the image was yet unclear (FIG. 4).

The image-formed copper plate by a painting material was dried for a short period of time (more than 2 minutes). To reduce the surface roughness of the copper plate, the sanding process was performed using a sand paper (S116). After the sanding, the distinct image with value color was patterned on the copper plate (FIG. 5).

As shown in FIG. 6, to prevent the degradation or discoloration of the copper plate or its damages by the end-user's careless handling and to ensure the long-term maintenance of glossiness for the impact resistance effect, the copper plate was finally coated with a protective film (S118), thus completing the fabrication of the high density copper plate memorial.

According to the manufacturing method of this invention, the high-density concave dots are engraved on the copper plate unlike the prior art, thus providing the high-clarity copper plate memorial. Further, according to this invention, the general discolored photos or basic frame are reproduced in the form of copper plate for semi-eternal preservation.

Through the following several steps, therefore, this invention can provide the copper plate memorial with the high-density image, which cannot be realized in the convention copper plate material having 90 dots per cm²: (1) a step of digitalizing the desired image for its storage in a computer file, (2) a step of converting the stored image into halftone image using a graphic edition program, (3) a step of printing the halftone image into a transparent film as a raw data for micro-dots, and (4) the copper plate is etched.

More specifically, the number of dots in the copper plate manufactured according to this invention can be increased up to 1000˜1600 dots per cm². Therefore, this invention can reproduce the high-density and high-image, since micro-particles of image are engraved on the copper plate.

1. Manufacturing method for the high density type copper plate memorial, wherein it comprises the following steps of:
digitalizing the desired image for its storage in a computer file (S100);
adjusting the image level by converting the stored image into halftone image (S102);
printing the halftone image into a transparent film (S104);
coating the surface of the foreign materials-free copper plate with a glue containing a hardening agent and photosensitizer, followed by its drying (S106);
compressing the printed image film to the copper plate for its photosensitization (S108);
heating the glue for appropriate etching (S110);
etching the surface of copper plate using an impregnating agent to form about 1000˜1600 dots per cm² (S112);
coating the etched copper plate with a painting material to obtain the same image as the image printed on a film (S114);
sanding the copper plate to obtain the desired surface roughness (S116); and,
coating the copper plate with a protective film so as to protective the surface of the copper plate where the above mentioned image is formed (S118).
